(19) United States
(12) Patent Application Publication
(10) Pub. No.: US 2008/0166082 A1
(43) Pub. Date: Jul. 10, 2008

(54) Multiple-Row Angular Contact Antifriction Bearing, Particularly For Mounting the Bevel Pinion Shaft in a Motor Vehicle Rear Axle Differential

(75) Inventors: Heinrich Hofmann, Schweinfurt (DE); Horst Doeppling, Herzogenaurach (DE); Robert Plank, Weisendorf (DE); Arbogast Grunau, Weisendorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/994,179

(22) PCT Filed: Jun. 27, 2006
(86) PCT No.: PCT/DE2006/001095

§ 371 Date: Feb. 14, 2008

(30) Foreign Application Priority Data
Jun. 28, 2005 (DE) 10 2005 029 983.0

(51) Int. Cl. F16C 19/38

(52) U.S. Cl. 384/613

(57) ABSTRACT

The multiple-row angular contact antifriction bearing has an outer bearing ring, an inner bearing ring, and roll bodies, which are arranged at least in two rows next to one another between the bearing rings. The roll bodies are ball discs having two lateral surfaces that are symmetrically flattened from a spherical basic shape whose raceways are arranged inside the bearing rings, abutting against one another so that the respectively adjacent roll bodies of each row have their lateral surface pointing toward one another and arranged directly next to one another on a transversal axis situated at a right angle to the pressure angle axes. These lateral surfaces also provide mutual guide surfaces.

### FIELD OF THE INVENTION

The invention relates to a multiple-row angular contact antifriction bearing according to the features of patent claim 1 which form the preamble, and it can be realized particularly advantageously in a double-row angular contact antifriction bearing for mounting the bevel pinion shaft in a motor vehicle rear axle differential.

### BACKGROUND OF THE INVENTION

It is generally known to a person skilled in the art of motor vehicle gear mechanism technology that, in a motor vehicle having rear axle drive, the engine torque is transmitted, after an automatic or manual transmission, via a bevel pinion shaft having a bevel pinion and via a ring gear to the drive axle which comprises two axle shafts, the rotational speed difference between the two axle shafts when driving around a bend being compensated for by a differential gear mechanism which comprises a plurality of differential gears. The bevel pinion shaft is held in the housing of the rear axle differential via two angular contact antifriction bearings which are spaced apart from one another and, on account of the high loading which results from the high torques which are to be transmitted and because of the limited installation space, are usually configured as two tapered roller bearings which are set against one another and are prestressed in the axial direction. Said tapered roller bearings are configured with a great contact angle because of the high axial forces which occur, and ensure high rigidity of the bevel pinion in tooth engagement.

Since, however, sliding friction occurs in tapered roller bearings of this type on account of their prestress between the end face of the tapered rollers and the guide face of the bearing flange, as a result of which sliding friction wear occurs on the tapered rollers and on the bearing flange, it has been proposed in DE 198 39 481 A1 to replace the tapered roller bearings by double-row tandem angular contact ball bearings which can be loaded on one side and are set against one another in an O-arrangement. Said tandem angular contact ball bearings comprise substantially an outer bearing ring and an inner bearing ring and a multiplicity of bearing balls which are arranged next to one another in two rows between the bearing rings and are held at uniform spacings from one another in the circumferential direction by two separate bearing cages for each row. The inner side of the outer bearing ring is configured with two adjacent raceways which are each delimited on one side by a shoulder and are arranged on common contact angle axes with two adjacent raceways in the outer side of the inner bearing ring which are likewise each delimited on one side by shoulders. In each case one row of the bearing balls rolls with their running faces on said raceways, the diameters of the raceways being different and the diameters of the bearing balls being identical. The use of tandem angular contact ball bearings of this type instead of tapered roller bearings is intended to achieve a situation where, on account of the sliding friction which is then absent between the bearing balls and the raceway shoulders, a substantially lower frictional moment results, as a result of which the wear and the temperature of the bearing is reduced and its degree of efficiency is improved.

Nevertheless, the replacement of this type, of tapered roller bearings by double-row tandem angular contact ball bearings has proven disadvantageous in practice to the extent that said angular contact ball bearings require an increased axial installation space in comparison with tapered roller bearings as a result of the raceways which are arranged one behind the other for the bearing balls and also the large diameters of the bearing balls for achieving the required loadbearing capability and as a result of their bearing cages. Moreover, if an angular contact ball bearing of this type is also intended to have a higher loadbearing capability than a tapered roller bearing, extensive changes to the bearing seats in the housing of the rear axle differential are therefore necessary, which changes increase its production costs in a disadvantageous manner. Moreover, double-row angular contact ball bearings of this type also cause increased production and material expenditure during bearing production in comparison with tapered roller bearings, with the result that their production costs are likewise increased. Furthermore, the necessarily different configuration of the raceway radii in comparison with the ball radii in angular contact ball bearings of this type has proven disadvantageous to the extent that the bearing balls are only in punctiform contact with their raceways as a result and therefore cause a high surface pressure on the raceways in the region of the contact angle axis, which high surface pressure is a cause of increased wear of said raceways. In addition, high edge stresses occur as a result of the bearing balls in the region of this shoulder edge which overlap the shoulder edge of the raceways in the case of normal osculation but bear against the shoulder edge when the osculation is used up, as a result of which high edge stresses the wear of the raceways of the bearing balls is increased still further and the service life of angular contact ball bearings of this type is reduced considerably.

### OBJECT OF THE INVENTION

Proceeding from the cited disadvantages of the solutions of the known prior art, the invention is therefore based on the object of designing a multiple-row angular contact antifriction bearing which is distinguished in comparison with multiple-row angular contact ball bearings by a minimized axial and radial installation space with identical or increased loadbearing capability and by low production and material expenditure and therefore by low production costs, and by way of which increased wear of the raceways of the rolling bodies which results from a high surface pressure and a high edge stress as a result of the rolling bodies is avoided effectively and therefore the service life of the angular contact antifriction bearing is increased.

### DESCRIPTION OF THE INVENTION

According to the invention, this object is achieved in a multiple-row angular contact antifriction bearing according to the preamble of claim 1 in such a way that the rolling bodies of each row are configured as spherical disks having in each case two side faces which are flattened symmetrically from a basic spherical shape, are arranged parallel to one another and the raceways of which have contact angle axes, which extend parallel to one another in the bearing rings, and are arranged adjacently to one another in such a way that the respectively adjacent rolling bodies of each row are arranged with their directly adjacent side faces which point toward one another, on a common transverse axis which extends at right angles to the contact angle axes, and these side faces are configured at the same time as mutual guiding faces.

The solution according to the invention is therefore based on the realization that it is possible, as a result of the use of spherical disks as rolling bodies, in which those regions of a ball which are not in rolling contact with the raceways anyway are omitted, to realize a narrow raceway spacing between the individual rolling body rows and thus to achieve an axial installation space which is smaller by from 10% to 20% for the bearing than multiple-row angular contact ball bearings, without having to accept reductions in the loadbearing capability of the angular contact antifriction bearing. Moreover, a further realization of the invention lies in the fact that the parallel side faces which are produced on the spherical disks can be used at the same time for automatic mutual guidance of the spherical disks in their raceways, with the result that, in conjunction with the rotational axes which are variable in ball bearings but remain constant in spherical disks and in interaction with a corresponding bearing cage, an offset which is probable in rolling bodies of this type can be almost precluded.

Preferred embodiments and advantageous developments of the multiple-row angular contact antifriction bearing which is configured according to the invention are described in the subclaims.

Consequently, according to claim 2, provision is made in the angular contact antifriction bearing configured according to the invention for the rolling bodies of each row to preferably have varying radii at their running faces. In the case of the mounting of the bevel pinion shaft in a motor vehicle rear axle differential by two angular contact antifriction bearings which are configured with two rows of spherical disks each and have different bearing diameters, it has proven particularly advantageous with regard to the radial and axial forces which are to be absorbed to configure the respectively first row of the spherical disks which is closest to or furthest from the bevel pinion, proceeding from a larger basic spherical shape, with a greater radius at their running faces and to provide a smaller radius for the running faces of the second row of the spherical disks, proceeding from a smaller basic spherical shape. However, in other applications of a double-row angular contact antifriction bearing according to the invention, it can also be advantageous to configure each row of the spherical disks with identical radii at their running faces or, in the case of angular contact antifriction bearings, having more than two rows of spherical disks, to configure the individual rows of the spherical disks with identical and nonidentical radii at their running faces and to combine them with one another in every possible form.

Proceeding from the above-described embodiment, it is a further feature of the angular contact antifriction bearing which is configured according to the invention, as claimed in claim 3, that the rolling bodies of each row preferably have different widths between their side faces or, as an alternative, are configured with the same width between their side faces. With regard to this, in the case of the mounting of the pinion bevel shaft in a motor vehicle rear axle differential by two angular contact antifriction bearings which are configured with two rows of spherical disks each and have different bearing diameters, it has also proven advantageous with regard to the radial and axial forces which are to be absorbed to configure the respectively first row of the spherical disks which is closest to or furthest from the bevel pinion, proceeding from a larger basic spherical shape, with a greater width between their side faces and to provide a smaller width between their side faces for the running faces of the second row of the spherical disks, proceeding from a smaller basic spherical shape. However, in other applications of a double-row angular contact antifriction bearing according to the invention, it can also be advantageous to configure each row of the spherical disks with the same width or, in the case of angular contact antifriction bearings having more than two rows of spherical disks, to configure the individual rows of the spherical disks with identical and nonidentical widths and to combine them with one another in every possible form.

Moreover, in accordance with claim 4, the angular contact antifriction bearing which is configured according to the invention is also distinguished by the fact that the rolling bodies, which are arranged in each case on a transverse axis, of each row are preferably arranged in a common pocket of the bearing cage which is preferably configured as a window cage. This has proven advantageous, in particular, in the case of angular contact antifriction bearings which are configured according to the invention and have more than two rows of spherical disks arranged next to one another, since the assembly costs for the bearing can be reduced considerably as a result. In the case of angular contact antifriction bearings which are configured according to the invention and have only two rows of spherical disks arranged next to one another, like those for mounting the bevel pinion shaft in a motor vehicle rear axle differential, it is also possible, however, to guide the spherical disks of both rows in the separate pockets of two comb-type cages or snap-action cages instead of in the common pocket of a window cage.

Furthermore, in accordance with claim 5, it is an expedient development of the angular contact antifriction bearing which is configured according to the invention that the running faces of the rolling bodies of each row preferably have the same radius as their raceways in the bearing rings and are in linear contact with the latter. Since, in contrast to conventional bearing balls, the spherical disks have a constant rotational axis, it is therefore possible to configure both the running faces of the spherical disks and the raceways in the bearing rings with the same radius and therefore, instead of the disadvantageous punctiform contact which occurs in known angular contact ball bearings between the rolling bodies and the raceways, to realize an advantageous linear contact, by which a uniform surface pressure with a low stress level between the rolling bodies and the raceways and at the same time an increase in the loadbearing capability of the angular contact antifriction bearing are achieved.

Finally, claims 6 and 7 also propose, as an advantageous refinement of the angular contact antifriction bearing which is configured according to the invention, that the raceways in the bearing rings, at their outer edge regions, and/or the running faces of the rolling bodies, at their edge parts which adjoin the side faces, each merge into a logarithmically falling profile, the surface proportion of those outer edge regions of the raceways which are configured with a logarithmically falling profile and/or of the edge parts of the running faces of the rolling bodies preferably being in each case approximately from 10% to 40% of a raceway face or of a running face of a rolling body. In the case of shoulder edges, which are configured so as to overlap the spherical disks at the same time, of the raceways of the bearing rings, the disadvantageous high edge stresses as a result of the rolling bodies can advantageously be avoided by this measure, which high edge stresses occur in the case of known angular contact ball bearings after the osculation in the region of the shoulder edges is used up, it having been proven sufficient in the case of the double-row angular contact antifriction bearings which are provided for mounting the bevel pinion shaft in a motor vehicle rear axle differential to configure only the running faces of the rolling bodies at their edge parts with a logarithmically falling profile.

The multiple-row angular contact antifriction bearing which is configured according to the invention therefore has the advantage over the angular contact antifriction bearings which are known from the prior art that, as a result of the use of spherical disks as rolling bodies, it is distinguished by a minimized axial and radial installation space with identical or increased loadbearing capability, above all in comparison with multiple-row angular contact ball bearings. Since spherical disks of this type can be produced similarly inexpensively as conventional ball bearings and the production expenditure of an angular contact antifriction bearing which is configured according to the invention is comparable with that of an angular contact ball bearing, favorable production costs for the angular contact antifriction bearing which is configured according to the invention can also be assumed as a result of the reduced material expenditure and the reduced weight. Moreover, the increased wear of the raceways of the rolling bodies which results in the case of known angular contact ball bearings from a high surface pressure and a high edge stress as a result of the rolling bodies can be avoided effectively by the linear contact between the rolling bodies and their raceways and by the configuration of the running faces of the rolling bodies with a logarithmically falling profile, with the result that angular contact antifriction bearings which are configured in this way also have an increased service life. The application range of angular contact antifriction bearings which are configured according to the invention is not restricted only to the double-row application which is mentioned by way of example for mounting the bevel pinion shaft in a motor vehicle rear axle differential but, in addition to many other possible applications, can also be extended individually to fixed bearings for mounting the main spindle of machine tools or also to four-row wheel bearings of motor vehicles in a double arrangement in an inverted mirror-image fashion directly next to one another. It is likewise conceivable to configure double-row or multiple-row radial antifriction bearings having rolling bodies which are arranged level next to one another with the same features according to the invention as the above-described angular contact antifriction bearing.

### BRIEF DESCRIPTION OF THE DRAWINGS

One preferred embodiment of the multiple-row angular contact antifriction bearing which is configured according to the invention will be explained in greater detail in the following text with reference to the appended drawings, in which:

FIG. 1 shows a partial view of a sectional illustration of a motor vehicle rear axle differential with the mounting of the bevel pinion shaft by two angular contact antifriction bearings which are configured according to the invention;

FIG. 2 shows an enlarged illustration of half of a cross section through an angular contact antifriction bearing which is configured according to the invention; and

FIG. 3 shows an enlarged illustration of the contact between a rolling body and its raceway in the outer bearing ring of the angular contact antifriction bearing which is configured according to the invention.

### DETAILED DESCRIPTION OF THE DRAWINGS

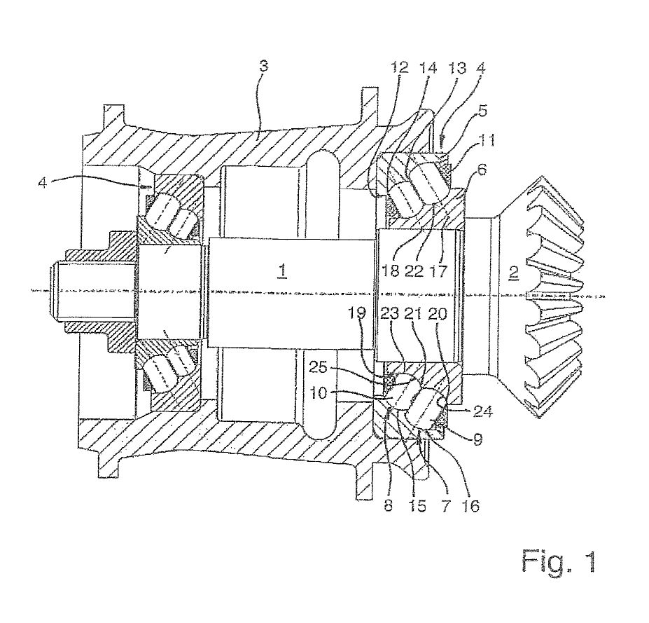

A part of a motor vehicle rear axle differential is clearly apparent from FIG. 1, with which the engine torque can be transmitted to the drive axle of a motor vehicle via a bevel pinion shaft 1 having a bevel pinion 2 and via a ring gear (not shown). The bevel pinion shaft 1 is held in the housing 3 of the rear axle differential via two angular contact antifriction bearings 4 which are spaced apart from one another, are set against one another and each comprise substantially an outer bearing ring 5 and an inner bearing ring 6 and a multiplicity of rolling bodies 9, 10 which are arranged next to one another in two rows 7, 8 between the bearing rings 5, 6 and are held at uniform spacings from one another in the circumferential direction by a bearing cage 11. The inner side 12 of the outer bearing ring 5 of both angular contact antifriction bearings 4 is configured with two adjacent raceways 15, 16 which are delimited in each case on one side by a shoulder 13, 14 and are arranged on common contact angle axes 17, 18 having two adjacent raceways 22, 23 in the outer side 19 of the inner bearing ring 5 which are likewise delimited in each case on one side by shoulders 20, 21 and on which in each case one row 7, 8 of the rolling bodies 9, 10 rolls by way of their running faces 24, 25.

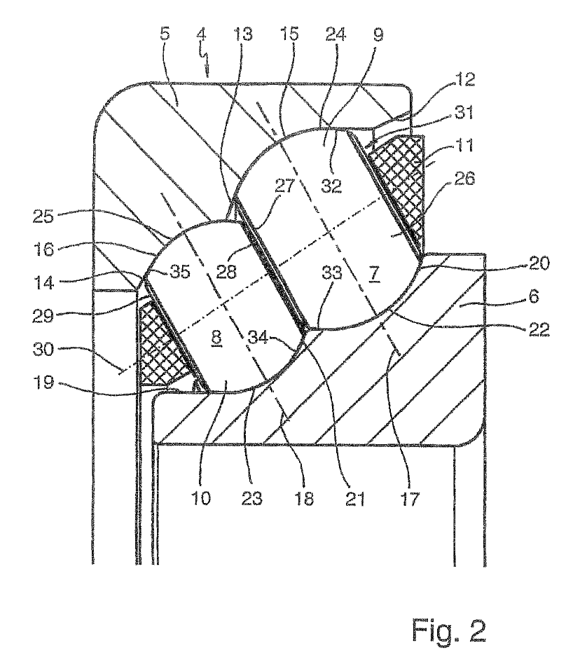

Moreover, it becomes clear from the pinion-side angular contact antifriction bearing 4 which is shown on an enlarged scale in FIG. 2 that, in the case of both angular contact antifriction bearings 4, the rolling bodies 9, 10 of each row 7, 8 are configured according to the invention as spherical disks having in each case two side faces 26, 27 and 28, 29 which are flattened symmetrically from a basic spherical shape, are arranged parallel to one another and the raceways 15, 16 and 22, 23 of which in the bearing rings 5, 6 have contact angle axes 17, 18 extending parallel to one another and are arranged so as to adjoin one another in such a way that the respectively adjacent rolling bodies 9, 10 of each row 7, 8 are arranged with their side faces 27, 28, which point toward one another, directly next to one another on a common transverse axis 30 which extends at a right angle to the contact angle axes 17, 18, and said side faces 27, 28 are configured at the same time as mutual guiding faces.

It can likewise be seen from FIG. 2 that the spherical disks of that first row 7 of the pinion-side angular contact antifriction bearing 4 which is closest to the bevel pinion 2, proceeding from a larger basic spherical shape, are configured with a greater radius at their running faces 24 and have a greater width between their side faces 26, 27 than the running faces 25 and the width between the side faces 28, 29 of the spherical disks, proceeding from a smaller basic spherical shape, of the second row 8 of the angular contact antifriction bearing 4. The rolling bodies 9, 10 of both rows 7, 8 which are configured in this way and are arranged on a transverse axis 30 are then arranged, as can be seen only in outline form in FIG. 2, in a common pocket 31 of the bearing cage 11 which is shown by way of example as a single-piece window cage.

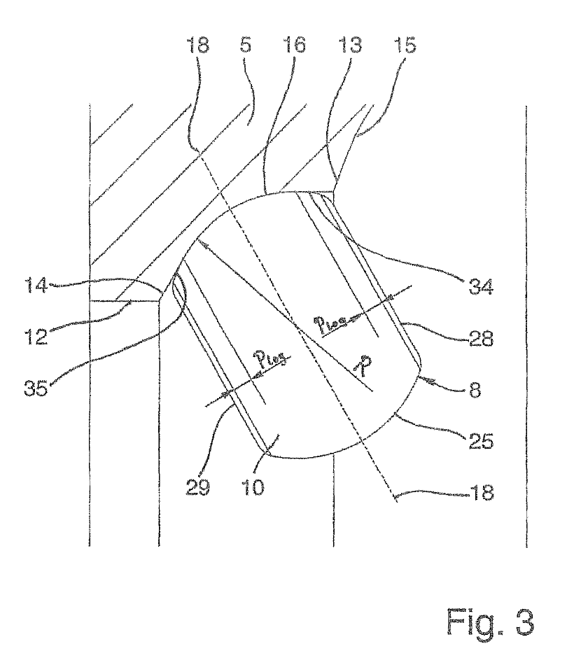

Finally, it is apparent from the illustration of the contact of the rolling bodies 10 with their raceway 16 in the outer bearing ring 5 of the angular contact antifriction bearing 4 which is configured according to the invention, which illustration is shown in FIG. 3 and is selected to represent the rolling bodies 9, 10 of both rows 7, 8, that the running faces 24, 25 of the rolling bodies 9, 10 of each row 7, 8 have the same radius R as their raceways 15, 16 and 22, 23 in the bearing rings 5, 6 and are in linear contact with the latter, with the result that a uniform contact pressure with a low stress level is achieved between the rolling bodies 9, 10 and the raceways 15, 16 and 22, 23. At the same time, in order to avoid disadvantageous high edge stresses which occur in the region of the shoulder edges, the running faces 24, 25 of the rolling bodies 9, 10 merge into a logarithmically falling profile, which is denoted by P_{log} in FIG. 3, at their edge parts 32, 33, 34, 35 which adjoin the side faces 26, 27, 28, 29, the surface area portion of said edge parts 32, 33, 34, 35 which are configured with a logarithmically falling profile being clearly discernibly approximately 20% of a running face 24,25 of a rolling body 9, 10.

### LIST OF DESIGNATIONS

1 Bevel pinion shaft
2 Bevel pinion
3 Housing
4 Angular contact antifriction bearing
5 Outer bearing ring
6 Inner bearing ring
7 Row
8 Row
9 Rolling body
10 Rolling body
11 Bearing cage
12 Inner side of 5
13 Shoulder
14 Shoulder
15 Raceway
16 Raceway
17 Contact angle axis
18 Contact angle axis
19 Outer side of 6
20 Shoulder
21 Shoulder
22 Raceway
23 Raceway
24 Running faces
25 Running faces
26 Side faces of 9
27 Side faces of 9
28 Side faces of 10
29 Side faces of 10
30 Transverse axis
31 Pocket of 11
32 Edge part of 24
33 Edge part of 24
34 Edge part of 25
35 Edge part of 25

1. A multiple-row angular contact antifriction bearing, for mounting on a the bevel pinion shaft in a motor vehicle rear axle differential, said multiple-row angular contact antifriction bearing comprising: an outer bearing ring and an inner bearing ring and a multiplicity of rolling bodies which are arranged at least in two rows next to one another between the bearing rings and are held in the circumferential direction at uniform spacings from one another by at least one bearing cage, the inner side of the outer bearing ring being configured with at least two adjacent raceways which are delimited on one side by a shoulder and are arranged on common contact angle axes having at least two adjacent raceways, which are likewise delimited on one side by shoulders and on which one row each of the rolling bodies rolls by way of their running faces, in the outer side of the inner bearing ring, wherein the rolling bodies of each row are configured as spherical disks having two side faces each which are flattened symmetrically from a basic spherical shape, are arranged parallel to one another and the raceways of which have contact angle axes, which extend parallel to one another in the bearing rings, and are arranged adjacently to one another in such a way that the respective adjacent rolling bodies of each row are arranged with their directly adjacent side faces which point toward one another, on a common transverse axis which extends at right angles to the contact angle axes, and these side faces are configured at the same time as mutual guiding faces.

2. The multiple-row angular contact antifriction bearing as claimed in claim 1, wherein rolling bodies of each row have different radii at their running faces or, as an alternative, each row is configured with identical radii at their running faces.

3. The multiple-row angular contact antifriction bearing as claimed in claim 1, wherein the rolling bodies of each row have different widths between their side faces or, as an alternative, are configured with the same width between their side faces.

4. The multiple-row angular contact antifriction bearing as claimed in claim 1, wherein the rolling bodies, which are each arranged on a transverse axis, of each row are arranged in a common pocket of the bearing cage which is preferably configured as a window cage.

5. The multiple-row angular contact antifriction bearing as claimed in claim 1, wherein the running faces of the rolling bodies of each row preferably have the same radius as their raceways in the bearing rings and are in linear contact with the latter.

6. The multiple-row angular contact antifriction bearing as claimed in claim 5, wherein the raceways in the bearing rings, at their outer edge regions, and/or the running faces of the rolling bodies, at their edge parts which adjoin the side faces, each merge into a logarithmically falling profile.

7. The multiple-row angular contact antifriction bearing as claimed in claim 6, wherein surface portion of those outer edge regions of the raceways which are configured with a logarithmically falling profile and/or of the edge parts of the running faces of the rolling bodies is in each case approximately from 10% to 40% of a raceway face or of a running face of a rolling body.
